(19) United States
(12) Patent Application Publication
(10) Pub. No.: US 2017/0344205 A1
(43) Pub. Date: Nov. 30, 2017

(54) SYSTEMS AND METHODS FOR DISPLAYING AND NAVIGATING CONTENT IN DIGITAL MEDIA

(71) Applicant: Apple Inc., Cupertino, CA (US)

(72) Inventors: Jaden M. GELLER, Folsom, CA (US); Charles J. MIGOS, Millbrae, CA (US); Brett RAMPATA, San Francisco, CA (US); Casey M. DOUGHERTY, San Francisco, CA (US)

(21) Appl. No.: 15/243,831

(22) Filed: Aug. 22, 2016

Related U.S. Application Data
(60) Provisional application No. 62/217,017, filed on Sep. 10, 2015.

(51) Int. Cl. G06F 3/0483; G06F 3/0482; G06F 3/0484; G06F 3/0488

(52) U.S. Cl. CPC G06F 3/0483; G06F 3/0488; G06F 3/0482; G06F 3/04845

(57) ABSTRACT

A method for navigating a digital media on an electronic device that can include receiving a digital book comprising a page including an associated content map of the digital media, where the content map provides the size, shape and location of content panels on the page, and displaying the page including the content panels on a display of the electronic device. The method can include receiving input to display a selected content panel in a prominent state on the display and displaying the selected panel in a prominent state on the display.

### CROSS-REFERENCE TO RELATED APPLICATIONS

The present application claims the benefit of U.S. Provisional Application No. 62/217,017, entitled “SYSTEMS AND METHODS FOR DISPLAYING AND NAVIGATING CONTENT IN DIGITAL MEDIA” filed Sep. 10, 2015, the content of which is incorporated herein by reference in its entirety for all purposes.

### FIELD

The present disclosure relates generally to applications for viewing digital media on a computing device. More specifically, the present embodiments relate to navigating content of content on a page of digital media at the computing device.

### BACKGROUND

The prevalence of portable computing devices has led to the popularity of digital media that can be accessed from almost anywhere at anytime. Some forms of digital media include digital books that include text and images. When viewed on an electronic device, and in particular portable electronic devices, some digital books can be tedious for a user to navigate through, because of the organization of the images in the digital books. For example, a user may be required to manually navigate through and center certain images without any assistance from the portable device. As a result, the user may spend more time thinking about how to position the images than absorbing the material they are viewing.

### SUMMARY

This paper describes various embodiments that relate to methods and systems for displaying and navigating contents on an electronic device. In some embodiments relate to defining contents for the display and navigation on an electronic device.

Some embodiments can include a method for navigating a digital media on an electronic device that can include displaying from a digital book a page having an associated content map of the digital book, where the content map provides the size, shape and location of content panels on the page including the content panels on a display of the electronic device. The method can include receiving input to display a selected content panel in a prominent state on the display and displaying the selected panel in a prominent state on the display.

In some embodiments the digital media can have multiple pages and each page can have multiple content panels. Some embodiments can include receiving input to display the content panel in a further enlarged state on the display and displaying the content panel in the further enlarged state on the display. In some embodiments the content map can further provide a sequential order for navigating the multiple content panels of a page. Some embodiments can include receiving input to navigate from the panel displayed on the display to a next panel as provided by the content map and displaying a next content panel in an enlarged state. In some embodiments the content panels can be navigated in sequential order, reverse sequential order, or randomly. In some embodiments navigation can be automated.

Some embodiments can include an electronic device for navigating content panels of pages of a digital book where the electronic device has a display to display pages of the digital book and an input interface to receive input related to displaying and navigation of content located on the pages of a digital book. The electronic device can have memory to receive and store the digital book and an associated content map providing the size, shape and location of content on the page. The electronic device can have a processor to process input received from the input interface related to displaying the content.

In some embodiments the display can be a touch-interface display. In some embodiments the content map can further provide content sequence ordering for navigation. In some embodiments particular content can be displayed on the display in an enlarged state in response to an input. In some embodiments other content in the panel mapping sequential order can be displayed in response to an input to proceed with navigation. In some embodiments navigation can be in sequential order, reverse sequential order, or random. In some embodiments when the content is displayed in the enlarged state it can extend from a first side to a second side of the display. In some embodiments the content can be displayed in a further enlarged state and can extend from a top side to a bottom side of the display.

Some embodiments can include a non-transitory machine-readable storage medium to store instructions that when executed on a computing device cause the computing device to perform steps that can include receiving a digital book having pages with content and a background and accessing metadata of the digital book having a content map providing for attributes of the content. The computing device can include displaying a page of the digital book at a display associated with the computing device, receiving input to display a selected content from the displayed page, and displaying the selected content.

In some embodiments the attributes of the content can include size, shape and location. In some embodiments when displaying the selected content, the background and non-selected content can be shown in a faded and/or blurred state. In some embodiments the content map can include a navigation order between multiple pieces of content on the page. Some embodiments can include receiving input to navigate between pieces of content on the page according to the navigation sequence.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 shows a diagram for creating, distributing and displaying digital media such as a comic book in accordance with some embodiments.

FIG. 2 shows an electronic device displaying a digital media page with content panels in accordance with some embodiments.

FIG. 3 shows an exemplary English language reading direction for the digital media page of FIG. 2 in accordance with some embodiments.

FIG. 4A shows a content panel of a page of the digital media of FIG. 2 being selected, in response to a user input, in accordance with some embodiments.

FIG. 4B shows the selected content panel of FIG. 3A, enlarged in the display in accordance with some embodiments.

FIG. 4C shows the selected content panel of FIG. 3A, enlarged in the display where the panel fills the display from left to right in accordance with some embodiments.

FIG. 4D shows the selected content panel of FIG. 3A, further enlarged in the display where the panel fills the display from top to bottom in accordance with some embodiments.

FIG. 5A shows the selected content panel of FIG. 3A and a swipe input from a user initiating navigation in accordance with some embodiments.

FIG. 5B shows navigation to the next sequential content panel of FIG. 3A in response to input from a user in accordance with some embodiments.

FIG. 6A shows the selected content panel of FIG. 3A and a touch input from a user on a random panel initiating navigation in accordance with some embodiments.

FIG. 6B shows the selected content panel of FIG. 3A in response to the touch input from a user on the selected panel in accordance with some embodiments.

FIG. 7 shows a flow chart of a method for displaying and navigating content mapped from a digital media page in accordance with some embodiments.

FIG. 8 is a block diagram of a computing device that can represent the components of the electronic device in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Comic books, and similar media, are primarily graphic based, having graphics panels that are read in a particular order to follow the sequence of the story. Typically, comic books are read starting at the top and moving left to right when the comic is in English, or right to left when in Japanese. Reading comics on a digital device is done in much the same way. That said, some digital devices, depending on the screen size, can make viewing the particular panels difficult when a whole page is displayed on a smartphone display, for instance. Zooming in and out and moving around on a page is sometimes possible, but the interaction experience is cumbersome. Navigating around the page to view the comic book panels by manually manipulating the page while reading, feels unnatural leaving much to be desired in the way of a user experience. While comic books are mostly graphic, they usually contain text within the panels. The text itself can often be stylized to coordinate with the graphically focused storytelling theme of a comic. Even displaying the text in a zoomed manner can leave much to be desired. The embodiments described herein ameliorate many of these problems and provide an enriched user experience to users when viewing digital media on electronic devices.

Described embodiments generally relate to methods and systems for displaying and navigating content on an electronic device. Some embodiments relate to displaying the content on a portable electronic device such as a tablet or smartphone, smart watch or other similar device. More specifically, embodiments described herein can use content mapping for displaying a selected content for prominent isolated viewing. The content mapping can be pre-defined by an author or publisher or the like. Alternatively, contents can be auto-detected and a content map can be generated.

Embodiments using content mapping can display a particular content panel in a more prominent manner, such as enlarged and isolated, on the screen of an electronic device so it is easier to see. The content can be displayed in response to an input received from a user. The content can also be displayed automatically, for instance as a first content panel in a comic book when beginning navigation of the book. Displaying the content in an isolated enlarged state is particularly useful in small portable electronic devices such as smartphones, but is helpful on many electronic devices for a better viewing experience. Once a content panel is more prominently displayed, navigation can be performed, from input by a user, or automatically, along the natural progression of the contents on the page. Navigation can also proceed to any other content on a page, as dictated by the input of the user. Various types of input can lead to any number of ways of navigating around the contents of a page or even back to the entire page as a whole.

In some embodiments, content can be zoomed in on and/or shown in darker, bolder, display resolution than its surroundings. In some embodiments, when a panel is enlarged or zoomed in on, the panel can fill the entire display along its width from left to right. In some cases the panel will not necessarily fill the display form top to bottom but the background area surrounding the panel can fill the rest of the display. In some embodiments, the content can be further enlarged in response to a user input and the content can fill the display from top to bottom. Depending on the configuration of the content, the display can crop part of the content. In this case the content can be moved left to right, by a user input such as dragging, to move all areas of the content around to be seen within the display screen.

In some embodiments the background can include contents adjacent the selected content and the adjacent elements can be shown in a muted, blurred and/or lightened state, for example, using a filter, mask or other method. This can be used to fade the adjacent elements and the rest of the page, seemingly into the background, thus more prominently displaying the selected content.

Embodiments can utilize input from a user of an electronic device to control navigation between a selected panel and other panels of a comic book page. Navigation from panel to panel can proceed as if a reader were reading the comic story from beginning to end. Embodiments can also allow for navigation to a previous panel or any panel or content on the page in response to input from the device user. In some embodiments, swipe gestures, left and right for example, which are just one form of input from a user that can be utilized, can be used for single-panel navigation forward or backward.

In some embodiments, specific content panel gestures can provide input for controlling the direction and speed of navigation, corresponding to the direction and speed of the gesture. For example, swipe gestures that are quick and predominantly horizontal can be treated as single-panel navigation gestures that either advance or move backwards one panel. On the other hand, slower gestures with the non-horizontal direction can be treated as gestures selecting a specific panel (e.g., the panel on which the input is centered when the user finishes the gesture). Displaying the faded non-selected panels of the page around a selected panel can enable these gestural movements. Transition effects can be used in some embodiments, such as when navigating from one content panel to the next, the first panel can appear to zoom out as the screen pans toward the next panel, which sequentially zooms into view, providing a dynamic user experience. Various other inputs, navigation modes and transitions are also possible.

Some embodiments can use content mapping provided by creators of digital media, such as publishers, authors and the like, that can denote the content on a page. Other embodiments can use content mapping provided with the digital media that includes auto-detection of the content. The content mapping can be included with the digital media as metadata. In some embodiments the computing device that displays the digital media can include a program for generating content mapping to be used for the navigation on the client device.

The authors or publishers, in some embodiments, can specify a navigation order through the content. For example, rather than always using left-to-right/top-to-bottom order, some embodiments can allow the authors or publishers to order the panels on a page in any desired order (for example clockwise). In some embodiments, the authors or publishers can reorder the content by creating a list or use of a special tool to draw the order (for example with arrows) on a layout of the page. In some embodiments, the navigation order can be auto-detected and determined given the natural reading sequence of the book. This can be done by automatically determining an order of the content on the page by analyzing the content locations. For instance, when a content panel is detected to be closer to the top of a page or more to the left or right (depending on the reading order of the page) the content panel can be prioritized in the reading progression order.

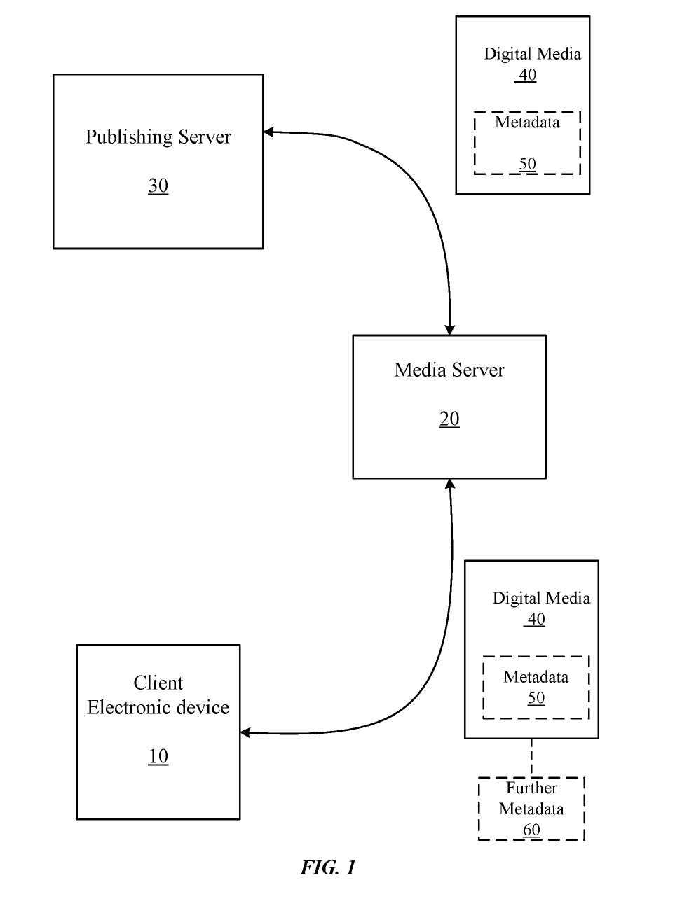

These and other embodiments are discussed below with reference to FIGS. 1-10; however, those skilled in the art will readily appreciate that the detailed description given herein with respect to these figures is for explanatory purposes only and should not be construed as limiting.

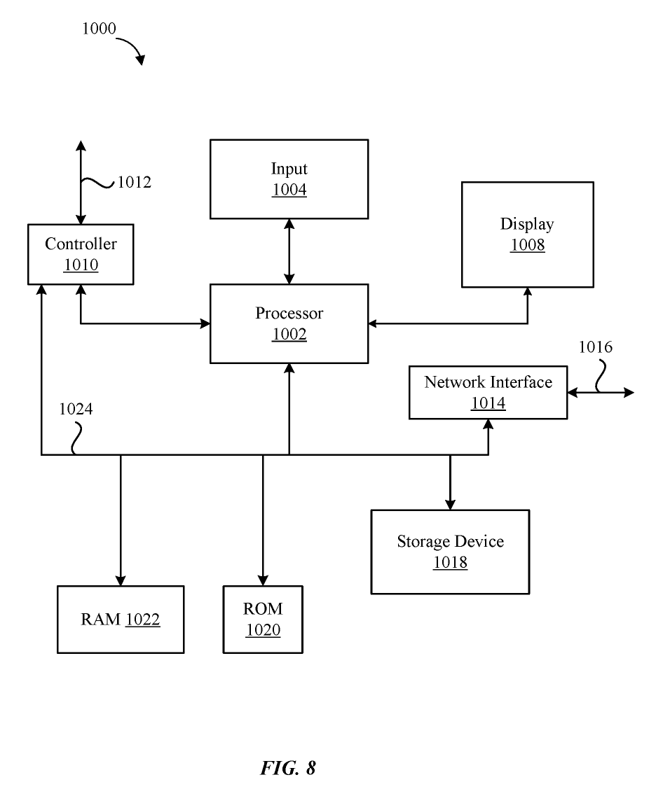

FIG. 1 shows a system for creating, distributing and displaying digital media 40. Digital media 40 can be created and stored on a publishing server 30 maintained by a publisher or author of digital media 40. Digital media 40 can take many forms such as comic books, recipe books, photo albums and other graphic intensive media. Publishing server 30 can be connected to a media server 20 for distributing digital media 40 to consumers. Media server 20 can include various distribution forms such as selling, licensing or renting and so on. Media server 20 can have a storefront for consumers to access for previewing, viewing and obtaining digital media 40. Media server 20 can have an applications store for providing an application for displaying the media as well as facilitating the ability to purchase digital media if applicable. Media server 20 can facilitate financial transactions for such purchases. Access to media server 20 and digital media 40, via the applications store for example, can be done by an electronic client device 10. Electronic client device 10 can take many forms such as a tablet, smartphone, watch, desktop computer, smart television and so on. The configuration of electronic device 10 is discussed in greater detail below with regard to FIG. 8.

Media server 20 can be configured to perform the method of some embodiments discussed herein. Specifically, embodiments with regard to auto-detection of content in digital media 20 can be performed at media server 20. Embodiments for auto-detection can also be performed at electronic client device 10 and/or at publishing server 30. Metadata 50 can accompany digital media 40. Metadata 50 can be generated at any of publishing server 30, media server 20 and/or electronic client device 10. In the illustrated embodiment metadata 50 can be in the form of content mapping prepared by the publisher or author that is associated with digital media 20. Digital media can be transmitted to media server 20 with metadata 50. Media server can perform methods in accordance with described embodiments and utilize metadata 50 and/or generate additional metadata 60. Additional metadata 60 can also be generated by electronic client device 10.

By way of example, a publisher might provide digital media 40 with a content map providing size, shape and location of the content in digital media 40. The publisher may not however provide any information on a navigation sequence in the content map. Media server 20 can perform the method in accordance with some embodiments described and auto-determine the navigation sequence from the size shape and location of the content as dictated by the content map and the language of digital media, such as English, which can also be included in metadata 50. The method for determining the navigation sequence can result in additional metadata 60 that can be associated with digital media 20. Digital media 20 with both metadata 50 and additional metadata 60 can be transmitted to electronic client device 10 for displaying digital media 40 to a consumer in an enriched user experience in accordance with some embodiments described herein.

Alternatively, a publisher may not provide any content information at all and only an image file of each page of digital media 40 is available. Then Media server and/or electronic client device 10 can perform the method of some embodiments and auto detect the content in digital media 40 and then associate this information with digital media 40. At this point digital media with the associated metadata 60 having the content map can be communicated between publishing server, media server and/or electronic client device 10 as the circumstance permits.

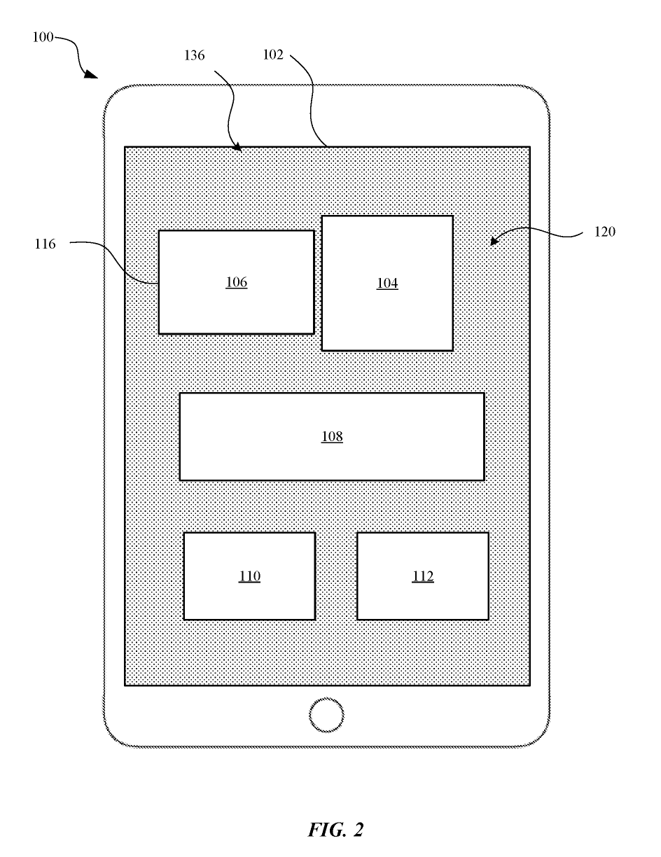

FIG. 2 shows an electronic device 100 having a display screen 102 for viewing a page 136 having content on electronic device 100. Display 102, can be a touchscreen interface that can communicate with a processor, shown in FIG. 8 and described further below. Display 102 can display digital media content such as comic books for viewing by a user. Content 106, 104, 108, 110 and 112, are illustrated as being displayed on page 136 displayed on display 102 and can take the form of panels or any other shape or configuration envisioned by an author as is common in comic books and similar digital media. A background 120 can surround content 106, 104, 108, 110 and 112. Background 120 is shown as uniform here, but can take many forms and can be solid, have a gradient appearance, or include graphics renditions, tonal and/or color variations, among numerous other options. Content 106, 104, 108, 110 and 112 combined with background 120 can make up a page (136). Digital media 40 can consist of one or multiple pages. Each page, as illustrated can have multiple pieces of content and/or a single piece of content. Content 106, 104, 108, 110 and 112 can overlap in some configurations and can have a boarder 116 for each respective panel. Since there are many different display sizes and resolutions of electronic devices and digital media, page sizes do not necessarily correlate to the proportions of all screens, in some embodiments, background 120 can be expanded to the edges of display 102 to ensure the display is always filled, even when the page itself would otherwise not entirely fill the screen.

In some embodiments page 136 can be a simple image file such as a JPEG or similar file and the location, size and shape of content 106, 104, 108, 110 and 112 in the image file is not a part of the page data. This makes it so that initially the image can only be displayed as a whole but only in a two-dimensional static way and content cannot be selectively displayed or navigated. To allow for selectively displaying and navigating the content of digital media in a dynamic manner, the location, size and shape of content 106, 104, 108, 110 and 112 needs to be mapped so electronic device 100 can display the content accordingly. A content map can be created in accordance with some embodiments either by auto-detecting the location, size and shape of content 106, 104, 108, 110 and 112 or by an author or publisher providing a content map with this information.

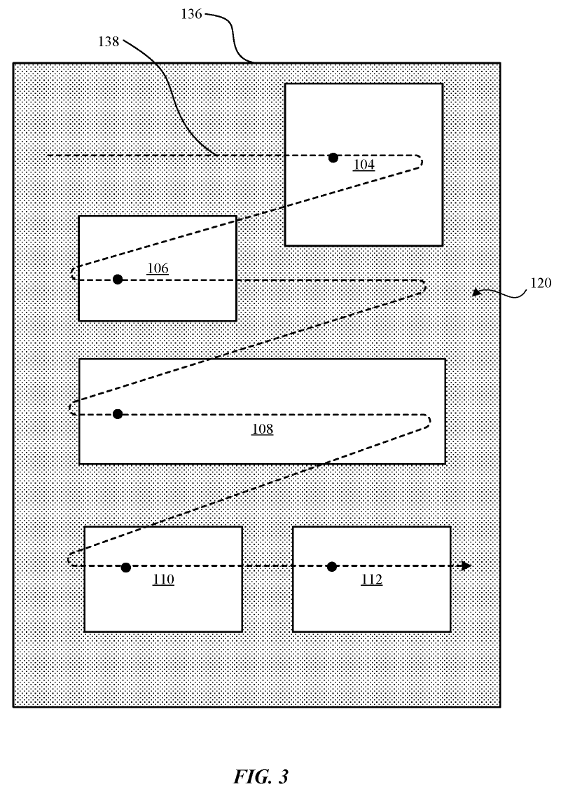

Navigation through content on a page of digital media is now described. For the purposes of illustration, if content 106, 104, 108, 110 and 112 were from an English comic book, the regular progression of the panels, would be in order of 106, 104, 108, 110 and then 112. If content 106, 104, 108, 110 and 112 were that of Japanese manga comic book, the natural progression would be 104, 106, 108, 112, then 110. For the purposes of the remainder of the this description, unless stated otherwise, the progression of the content 106, 104, 108, 110 and 112, in the order of the story will be that of an English comic book. FIG. 3 shows a navigation sequence 138 in accordance with the natural reading order of page 136 of digital media such as a comic book page in English.

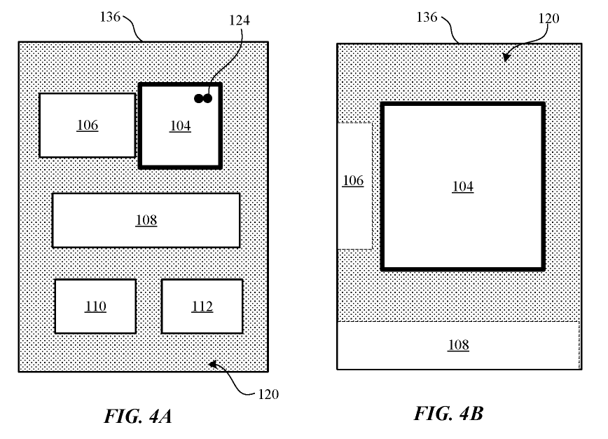

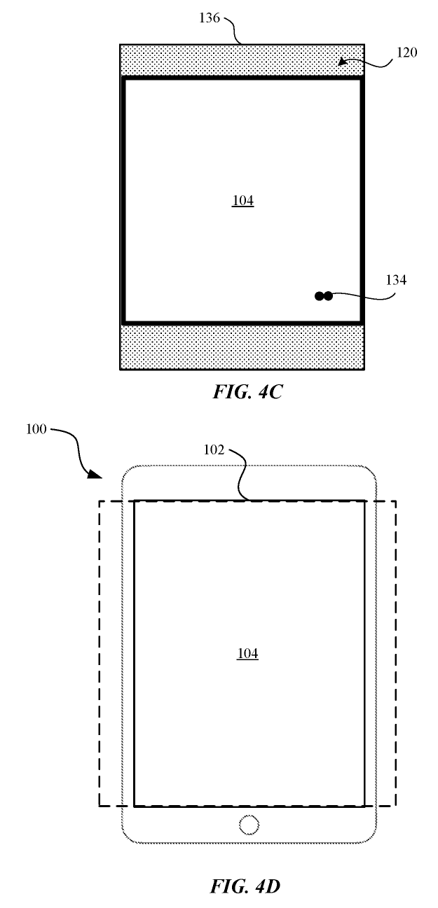

Navigation is described with reference to FIGS. 4A-6B. FIG. 4A shows display 102 and content 106, 104, 108, 110 and 112 as illustrated in FIG. 2. Here though, content 104 is highlighted to show that it has been selected by a touch interface input 124. In some embodiments touch input 124 can be single tap or double tap by a user on touch interface display 102 in the general vicinity of content 104. Other inputs are possible including using a pointing device connected to the electronic device and other types of electronic device input methods. When touch input 124 is received, selected content 104 is enlarged (i.e. zoomed in on) on display 102, as illustrated in FIG. 4B and shown more prominently, than content 106, 108 and background 120. Content 106 and 108 are shown in dashed lines to signify being displayed on display 102 in a muted, blurred and/or faded manner so as to contrast with content 104. Other means for showing the background 120, and content adjacent the selected panel 104, are possible such as masking, color de-saturating, brightness lightening or any number of other means for distinguishing these elements from the enlarged and prominently displayed selected panel 104. While not shown here, in some embodiments the content can be shown in parallax effect to provide further context for the content and to provide the look and feel of the content floating above the background and/or other elements of the page.

In some embodiments, when a content is enlarged or zoomed in on, the content, or any of the other selected and viewed, can fill the entire display along its width from left to right, but not necessarily top to bottom and the background can fill the rest of the display, where the content is not shown. FIG. 4C illustrates content 104 displayed on display 102 being extended entirely across display 102. Background 120 is still visible above and below content 104. Another user input 134, which can be a double tap, can zoom in on, and enlarge the content 104 even more, stretching it to the full length of the display 102, top to bottom, as shown in FIG. 4D. The dashed lines in FIG. 4D, illustrate the unseen portion of content 104 that are outside the viewing area of display 102, and thus a cropped view of content 104 is shown, but more detail of content 104 can be seen in this view. In some embodiments, content 104, in response to a user input such s dragging, can also be moved so all areas of content 104 can be seen within the display screen, though in this particular view, not simultaneously.

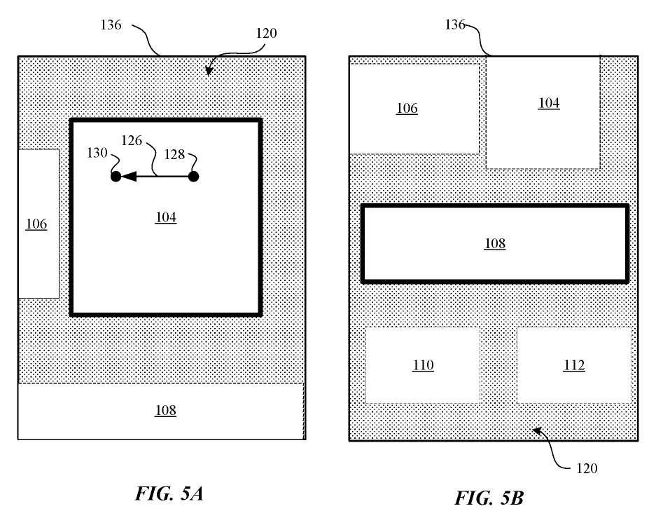

FIG. 5A illustrates selected content 104, enlarged on display 102, and further illustrates a input of a swipe 126 between dots 128 and 130 from right to left. As with all touch interface inputs described, the inputs can take the form of multiple different configurations. Here, though, the right to left swipe, can progress the content 104 to the next content 108 in the progression of the comic book story. FIG. 4B shows the transition after the comic book progresses and content 108 is now shown prominently displayed and enlarged. Content 110, 112, 104 and 106 are shown surrounding content 108 in their original configuration for context, but are again shown in dashed lines to illustrate being displayed less prominent.

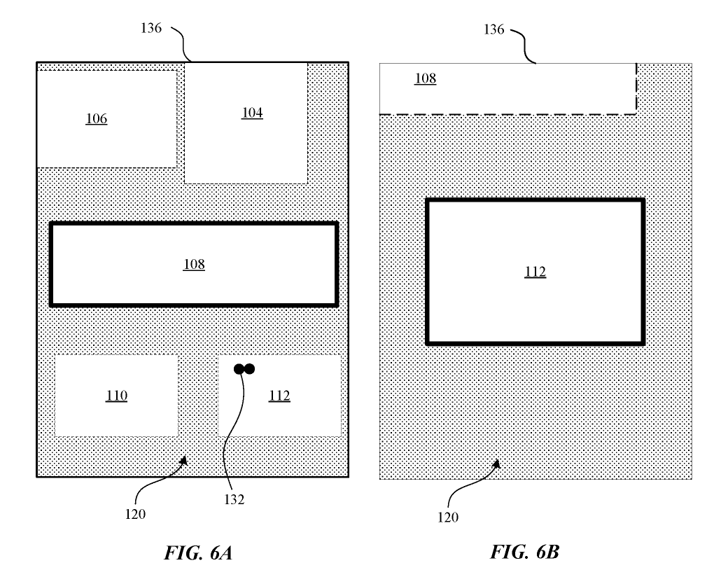

FIG. 6A illustrates content 108 similarly to FIG. 5B. In FIG. 5A, though, touch interface input 132 is shown as a single or double tap on content 112, which is not the next panel in the progression of the comic book story. Navigation, as described in connection with FIGS. 5A and 5B, can progress sequentially by swiping right to left, or even in reverse sequence by swiping left to right. Progression to any other panel within display 102 is also possible by a user selecting the content 112, whether it is in the sequential progression of the story or not. Once selected, as shown in FIG. 6B, the selected content 112 is displayed in an enlarged more prominent manner.

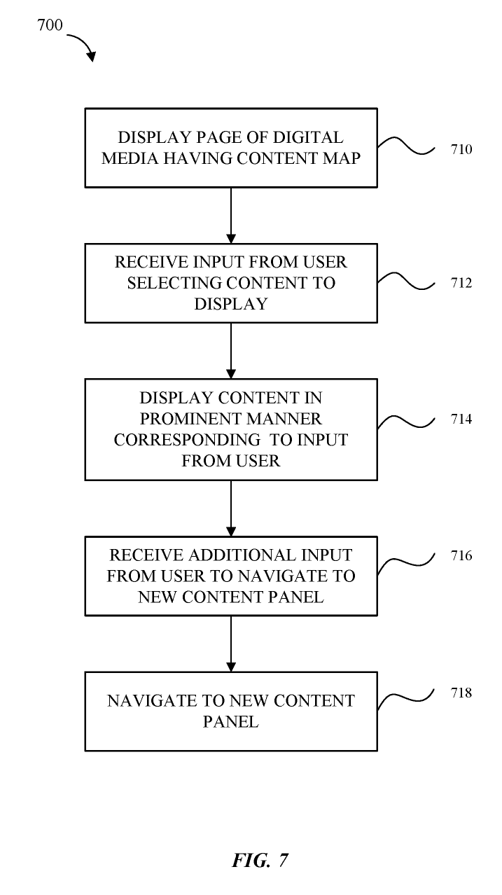

FIG. 7 shows a flow chart of a method 700 for displaying and navigating through content of digital media having a content map. Method 700 can begin by displaying a page of the digital media on the display of an electronic device in a first step 710. The display can be interactive and can be a touch screen. Input can be received in a step 712 identifying the content that a user wants to display more prominently on the display. The input can be by way of a finger tap or double tap from a user on the touch screen display interface or by way of mouse or clicking device or any other type of input method. Once the input is received, in a step 714, the content that corresponds with the input, is displayed more prominently at the display of the electronic device. Addition input received in step 716 dictates the next step of a method, which can be configured in a numerous ways. For the purposes of navigation and this exemplary embodiment, when input from the user in step 716 is received the content navigates and displays the next selected content in a prominent manner in a step 718 and the previously selected content is faded into the background. The next content selected can either be a next content penal in the sequence of the story of comic book, for example, or it can be a random panel selected to be displayed, even if it is out of the reading order of the story. Other input and navigation is possible and contemplated by this disclosure and the described embodiments.

FIG. 8 is a block diagram of a computing device 1000 that can represent the components of the electronic device. It will be appreciated that the components, devices or elements illustrated in and described with respect to FIG. 8 may not be mandatory and thus some may be omitted in certain embodiments. The computing device 1000 can include a processor 1002 that represents a microprocessor, a coprocessor, circuitry and/or a controller for controlling the overall operation of computing device 1000. Although illustrated as a single processor, it can be appreciated that the processor 1002 can include a plurality of processors. The plurality of processors can be in operative communication with each other and can be collectively configured to perform one or more functionalities of the computing device 1000 as described herein. In some embodiments, the processor 1002 can be configured to execute instructions that can be stored at the computing device 1000 and/or that can be otherwise accessible to the processor 1002. As such, whether configured by hardware or by a combination of hardware and software, the processor 1002 can be capable of performing operations and actions in accordance with embodiments described herein.

The computing device 1000 can also include user input device 1004 that allows a user of the computing device 1000 to interact with the computing device 1000. For example, user input device 1004 can take a variety of forms, such as a button, keypad, dial, touch screen, audio input interface, visual/image capture input interface, input in the form of sensor data, etc. Still further, the computing device 1000 can include a display 1008 (screen display) that can be controlled by processor 1002 to display information to a user. Controller 1010 can be used to interface with and control different equipment through equipment control bus 1012. The computing device 1000 can also include a network/bus interface 1014 that couples to data link 1016. Data link 1016 can allow the computing device 1000 to couple to a host computer or to accessory devices. The data link 1016 can be provided over a wired connection or a wireless connection. In the case of a wireless connection, network/bus interface 1014 can include a wireless transceiver.

The computing device 1000 can also include a storage device 1018, which can have a single disk or a plurality of disks (e.g., hard drives) and a storage management module that manages one or more partitions (also referred to herein as “logical volumes”) within the storage device 1018. In some embodiments, the storage device 1018 can include flash memory, semiconductor (solid state) memory or the like. Still further, the computing device 1000 can include Read-Only Memory (ROM) 1020 and Random Access Memory (RAM) 1022. The ROM 1020 can store programs, code, instructions, utilities or processes to be executed in a non-volatile manner. The RAM 1022 can provide volatile data storage, and store instructions related to components of the storage management module that are configured to carry out the various techniques described herein. The computing device 1000 can further include data bus 1024. Data bus 1024 can facilitate data and signal transfer between at least processor 1002, controller 1010, network interface 1014, storage device 1018, ROM 1020, and RAM 1022.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable storage medium. The computer readable storage medium can be any data storage device that can store data, which can thereafter be read by a computer system. Examples of the computer readable storage medium include read-only memory, random-access memory, CD-ROMs, HDDs, DVDs, magnetic tape, and optical data storage devices. The computer readable storage medium can also be distributed over network-coupled computer systems so that the computer readable code is stored and executed in a distributed fashion. In some embodiments, the computer readable storage medium can be non-transitory.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for navigating a digital book on an electronic device, the method comprising:
by a processor:
displaying from a digital book a page comprising an associated content map of the digital book, wherein the content map provides the size, shape and location of content panels on the page including the content panels on a display of the electronic device;
receiving input to display a selected content panel in a prominent state on the display; and
displaying the selected panel in a prominent state on the display.

2. The method of claim 1 wherein the digital book comprises multiple pages and each page comprise multiple content panels.

3. The method of claim 1 further comprising the step of: receiving input to display the content panel in a further prominent state on the display and displaying the content panel in the further prominent state on the display.

4. The method of claim 2, wherein the content map further provides a sequential order for navigating the multiple content panels of a page.

5. The method of claim 4, further comprising the step of: receiving input to navigate from the content panel displayed on the display to a next panel as provided by the content map and displaying a next content panel in an prominent state.

6. The method of claim 4 wherein the content panels can be navigated in sequential order, reverse sequential order, or randomly.

7. The method of claim 4 wherein navigation can be automated.

8. An electronic device for navigating content of pages of a digital book, the electronic device comprising:
a display configured to display pages of the digital book;
an input interface configured to receive input related to displaying and navigation of content located on the pages of a digital book;
memory configured to receive and store the digital book and an associated content map providing the size, shape and location of content on the page; and
a processor configured to process input received from the input interface related to displaying the content.

9. The electronic device of claim 8, wherein the display is a touch-interface display.

10. The electronic device of claim 9, wherein the content map further provides content sequence ordering for navigation.

11. The electronic device of claim 10, wherein particular content can be displayed on the display in an enlarged state in response to an input.

12. The electronic device of claim 11, wherein other content in the panel mapping sequential order can be displayed in response to an input to proceed with navigation.

13. The electronic device of claim 8, wherein navigation can be in sequential order, reverse sequential order, or random.

14. The electronic device of claim 11, wherein when the content is displayed in a the enlarged state it extends from a first side to a second side of the display.

15. The electronic device of claim 11, wherein when the content can be displayed in a further enlarged state and extends from a top side to a bottom side of the display.

16. A non-transitory machine-readable storage medium configured to store instructions that when executed by a processor of a computing device cause the computing device to perform steps that include:
receiving a digital book having pages with content and a background;
accessing metadata of the digital book having a content map providing for attributes of the content;
displaying a page of the digital book at a display associated with the computing device;
receiving input to display a selected content from the displayed page; and
displaying the selected content.

17. The non-transitory machine-readable storage medium of claim 16, wherein the attributes of the content include size, shape and location.

18. The non-transitory machine-readable storage medium of claim 16, wherein when displaying the selected content, the background and non-selected content is shown in a faded and/or blurred state.

19. The non-transitory machine-readable storage medium of claim 16, wherein the content map includes a navigation order between multiple pieces of content on the page.

20. The non-transitory machine-readable storage medium of claim 19, further comprising the step of receiving input to navigate between pieces of content on the page according to the navigation sequence.
